(19) United States
(12) Patent Application Publication
(10) Pub. No.: US 2025/0180807 A1
(43) Pub. Date: Jun. 5, 2025

(54) OPTICAL WAVEGUIDE STRUCTURE

(71) Applicant: FURUKAWA ELECTRIC CO., LTD., Tokyo (JP)

(72) Inventors: Noritaka MATSUBARA, Tokyo (JP); Atsushi KAJI, Tokyo (JP); Yozo ISHIKAWA, Tokyo (JP); Atsushi IZAWA, Tokyo (JP); Kazuya NAGASHIMA, Tokyo (JP)

(73) Assignee: FURUKAWA ELECTRIC CO., LTD., Tokyo (JP)

(21) Appl. No.: 19/046,779

(22) Filed: Feb. 6, 2025

Related U.S. Application Data
(63) Continuation of application No. PCT/JP2023/029112, filed on Aug. 9, 2023.

(30) Foreign Application Priority Data
Aug. 10, 2022 (JP) 2022-128408

(51) Int. Cl. G02B 6/122

(52) U.S. Cl. CPC G02B 6/122

(57) ABSTRACT

An optical waveguide structure includes: a first member having a first surface facing a first direction; a waveguide layer including a core layer extending in a second direction intersecting the first direction at a position apart from the first surface, and a cladding layer surrounding the core layer on the first surface, and including a protruding portion protruding in the first direction to a peripheral portion at a position on an opposite side to the first member at least with respect to the core layer, and an inclined portion arranged at a boundary between the protruding portion and the peripheral portion; a second member arranged on an opposite side to the first member with respect to an end portion in a longitudinal direction of the waveguide layer; and an adhesive configured to join the cladding layer and the second member at a position shifted from the inclined portion.

This application is a continuation of International Application No. PCT/JP2023/029112, filed on Aug. 9, 2023 which claims the benefit of priority of the prior Japanese Patent Application No. 2022-128408, filed on Aug. 10, 2022, the entire contents of which are incorporated herein by reference.

### BACKGROUND

The present disclosure relates to an optical waveguide structure.

As a known optical waveguide structure, a technique has been known in which mechanical properties, such as rigidity and strength, of a subassembly that integrates the optical waveguide structure and other components are improved by adding a component to the optical waveguide structure at a connection point with other members (for example, JP-A-2013-214115).

### SUMMARY

Regarding this type of optical waveguide structure, the inventors conducted intensive research, and discovered a structure that allows for further improvement in the mechanical properties of a subassembly that integrates the optical waveguide structure and other components.

There is a need for an optical waveguide structure with an improved and novel structure enabling to further improve the mechanical properties of, for example, a subassembly that integrates the optical waveguide structure and other components.

According to one aspect of the present disclosure, there is provided an optical waveguide structure including: a first member having a first surface facing a first direction; a waveguide layer including a core layer extending in a second direction that intersects the first direction at a position apart from the first surface, and a cladding layer surrounding the core layer on the first surface, the cladding layer including a protruding portion protruding in the first direction to a peripheral portion at a position on an opposite side to the first member at least with respect to the core layer, and an inclined portion arranged at a boundary between the protruding portion and the peripheral portion; a second member arranged on an opposite side to the first member with respect to an end portion in a longitudinal direction of the waveguide layer; and an adhesive configured to join the cladding layer and the second member at a position shifted from the inclined portion.

### BRIEF DESCRIPTION OF THE DRAWINGS

FIG. 1 is an exemplary and schematic side view of an optical waveguide structure according to a first embodiment;

FIG. 2 is an exemplary and schematic front view of the optical waveguide structure according to the first embodiment;

FIG. 3 is an exemplary and schematic plan view of the optical waveguide structure according to the first embodiment;

FIG. 4 is an exemplary and schematic front view of a portion of an optical waveguide structure according to a second embodiment;

FIG. 5 is an exemplary and schematic front view of a portion of an optical waveguide structure according to a third embodiment;

FIG. 6 is an exemplary and schematic front view of a portion of an optical waveguide structure according to a fourth embodiment;

FIG. 7 is an exemplary and schematic front view of a portion of an optical waveguide structure according to a fifth embodiment;

FIG. 8 is a cross-section cut along a line VIII-VIII in FIG. 7;

FIG. 9 is an exemplary and schematic plan view of a portion of the optical waveguide structure according to the fifth embodiment;

FIG. 10 is an exemplary and schematic front view of a portion of an optical waveguide structure according to a sixth embodiment;

FIG. 11 is an exemplary and schematic front view of a portion of an optical waveguide structure according to an seventh embodiment;

FIG. 12 is an exemplary and schematic front view of a portion of an optical waveguide structure according to an eighth embodiment; and

FIG. 13 is an exemplary and schematic front view of a portion of an optical waveguide structure according to a ninth embodiment.

### DETAILED DESCRIPTION

Hereinafter, exemplary embodiments will be disclosed. Configurations of the embodiments described below, and actions and results (effects) caused by the configurations are examples. The present disclosure may also be implemented by configurations other than those disclosed in the following embodiments. Furthermore, according to the present disclosure, it is possible to obtain at least one of various effects (including derivative effects) obtained from the configurations.

The embodiments described below have similar configurations. Therefore, according to the configuration of each embodiment, similar actions and effects based on these similar configurations may be obtained. Moreover, in the following, identical reference symbols will be assigned to similar configurations, and duplicated explanations may be omitted.

In the present specification, ordinal numbers are assigned for convenience to distinguish parts, directions, components, members, and the like, but are not intended to indicate priority or order, or to specify quantity.

In each drawing, an X direction is indicated by an arrow X, a Y direction is indicated by an arrow Y, and a Z direction is indicated by an arrow Z. The X direction, the Y direction, and the Z direction intersect with one another and are perpendicular to one another. Hereinafter, the X direction is also referred to as longitudinal or extending direction, the Y direction as lateral or width direction, and the Z direction as stacking or height direction.

The respective drawings are schematic diagrams provided for the purpose of explanation, and scales and proportions in the drawings do not necessarily correspond to those of actual objects.

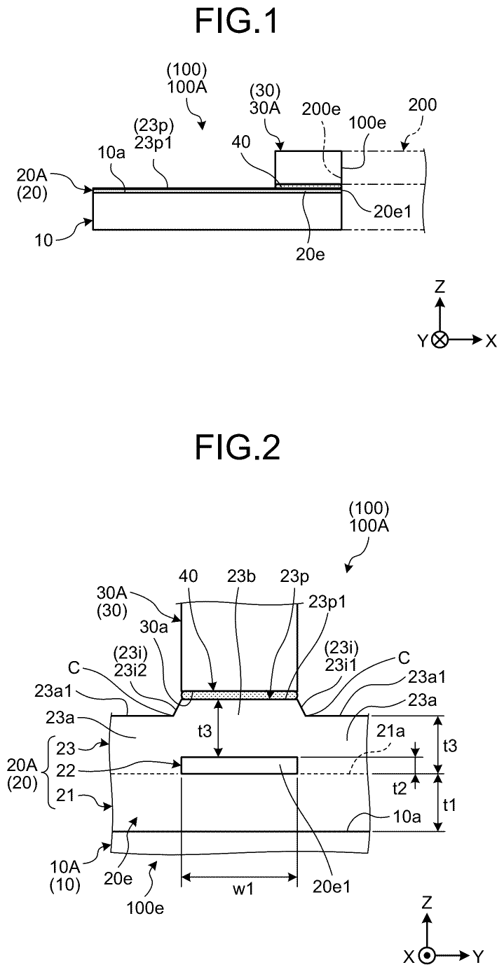

FIG. 1 is a side view of an optical waveguide structure 100A (100) according to a first embodiment. As illustrated in FIG. 1, the optical waveguide structure 100 includes a base 10, a waveguide layer 20A (20), a member 30A (30), and an adhesive 40. The base 10, the waveguide layer 20, the adhesive 40, and the member 30 are laminated in the Z direction. The member 30 is arranged on an opposite side to the base 10 relative to an end portion 20e in the X direction of the waveguide layer 20, that is, the end portion 20e in the longitudinal direction. The adhesive 40 joins the end portion 20e of the waveguide layer 20 and the member 30. The base 10 is one example of a first member. The adhesive 40 may also be referred to as bonding agent. The base 10 may also be referred to as substrate. Moreover, the base 10 and the waveguide layer 20 constitute a planar lightwave circuit (PLC).

As illustrated in FIG. 1, joined with an adhesive or the like in a state in which an end surface 100e of the optical waveguide structure 100 and an end surface 200e of another optical structure face each other, the optical waveguide structure 100 and an optical structure 200 are integrated. The end surface 100e is configured as an end surface of the base 10, the waveguide layer 20, the adhesive 40, and the member 30. An end surface 20e1 of the waveguide layer 20 positioned in the end surface 100e of the optical waveguide structure 100 is an input terminal or an output terminal of light. Moreover, the optical structure 200 is, for example, an optical-fiber supporting structure, an optical sensor, or the like, but it is not limited thereto. In the subassembly of the optical waveguide structure 100 and the optical structure 200, the waveguide layer 20 of the optical waveguide structure 100 and a waveguide (not illustrated) of the optical structure 200 are optically connected to each other.

If the optical waveguide structure 100 does not have the member 30 and the adhesive 40, and only has the base 10 and the waveguide layer 20, a thickness in the Z direction becomes thin compared to a structure having the member 30 and the adhesive 40. Therefore, the subassembly of the optical waveguide structure 100 and the optical structure 200 has a risk that it may become more prone to bending and breaking at a joint portion of the end surfaces 100e and 200e. Furthermore, because the end surface 100e is narrow, there is also a risk that the tensile strength becomes insufficient. In this regard, the optical waveguide structure 100 of the present embodiment has the member 30 and the adhesive 40 facing the optical structure 200 on an opposite side to the base 10 relative to the end portion 20e of the waveguide layer 20. As a result, compared to a configuration without the member 30 and the adhesive 40, it is easier to enhance mechanical properties, such as bending rigidity, bending strength, shear strength, and tensile strength, of the subassembly in which the optical waveguide structure 100 and the optical structure 200 are integrated. The member 30 is one example of a second member. The member 30 functions as a reinforcing member and may also be referred to as an upper plate, a jig, or the like.

FIG. 2 is a front view of a part of the optical waveguide structure 100A (100) and the end surface 100e according to the first embodiment. The base 10 is, for example, a silicone substrate. As illustrated in FIGS. 1 and 2, the base 10 is perpendicular to the Z direction and extends in the X direction and the Y direction. The base 10 includes a surface 10a. The surface 10a is an end surface in the Z direction. The surface 10a is perpendicular to the Z direction, and extends in the X direction and the Y direction. The Z direction is one example of a first direction. The surface 10a is one example of a first surface.

As illustrated in FIG. 2, the waveguide layer 20 includes a first cladding layer 21, a core layer 22, and a second cladding layer 23. The first cladding layer 21, the core layer 22, and the second cladding layer 23 are laminated on the surface 10a in this order by the chemical vapor deposition (CVD) method.

The first cladding layer 21 covers the surface 10a of the base 10 with a substantially uniform thickness t1 in the Z direction. The first cladding layer 21 is perpendicular to the Z direction, and extends in the X direction and the Y direction.

The core layer 22 is laminated on a portion of an upper surface 21a of the first cladding layer 21 with a substantially uniform thickness t2 in the Z direction. In other words, between the core layer 22 and the surface 10a of the base 10, the first cladding layer 21 is present. That is, the core layer 22 is positioned apart from the surface 10a in the Z direction. Moreover, at an end portion 20a of the waveguide layer 20, the core layer 22 extends in the X direction with a predetermined width w1. The X direction is one example of a second direction.

The second cladding layer 23 is laminated on the first cladding layer 21 and the core layer 22 with a substantially uniform thickness t3 in the Z direction. As described above, and as is evident from FIG. 2, the core layer 22 is laminated on the upper surface 21a of the first cladding layer 21. Therefore, in a state before the second cladding layer 23 is laminated, the core layer 22 protrudes from the upper surface 21a with the thickness t2 in the Z direction. Therefore, the second cladding layer 23 laminated on the first cladding layer 21 and the core layer 22 having such a shape and arrangement includes a portion 23a that is formed on the upper surface 21a, positioned off a core layer 221 and a portion 23b that is formed on the core layer 22, and a protruding portion 23p is formed in a portion on an opposite side to the base 10 relative to the core layer 22. The protruding portion 23p is a part of the portion 23b (an end portion in the Z direction). A top surface 23p1 of the protruding portion 23p, that is, the top surface 23p1 positioned at the end portion of the portion 23b in the Z direction, faces the Z direction, is perpendicular to the Z direction, and extends in the X direction and the Y direction. Moreover, a surface 23al positioned at the end portion of the portion 23a in the Z direction also faces the Z direction, is perpendicular to the Z direction, and extends in the X direction and the Y direction. The top surface 23p1 protrudes in the Z direction with a height substantially identical to the thickness t2 of the core layer 22 from the surface 23al. The surface 23al is one example of a peripheral portion of the protruding portion 23p, and may also be referred to as base surface or flat surface.

In such a configuration, the first cladding layer 21 and the second cladding layer 23 constitutes a cladding layer that surrounds the core layer 22 on the surface 10a of the base 10 and extends in the X direction.

The cladding layers, that is, the first cladding layer 21 and the second cladding layer 23, are made of, for example, silica-based glass material. The core layer 22 is made of, for example, silica-based glass material that has a refractive index higher than a refractive index of the first cladding layer 21 and the second cladding layer 23. The core layer 22 may be made of, for example, quartz glass containing germanium dioxide (GeO₂) or zirconia (ZrO₂) as dopants to increase the refractive index. The member 30 is made of, for example, silica-based glass material, borosilicate glass material, and the like. Furthermore, the adhesive 40 is made of, for example, epoxy resin, acrylic resin, vinyl resin, and the like.

In such a configuration, at a boundary between the protruding portion 23p and the surface 23al, an inclined portion 23i is formed. The inclined portion 23i includes an inclined portion 23i1 that is positioned at an end portion in the Y direction of the protruding portion 23p and an inclined portion 2312 that is positioned at an end portion in the opposite direction in the Y direction of the protruding portion 23p. The inclined portion 23i1 is one example of a first inclined portion, and the inclined portion 2312 is one example of a second inclined portion. The Y direction is one example of a third direction.

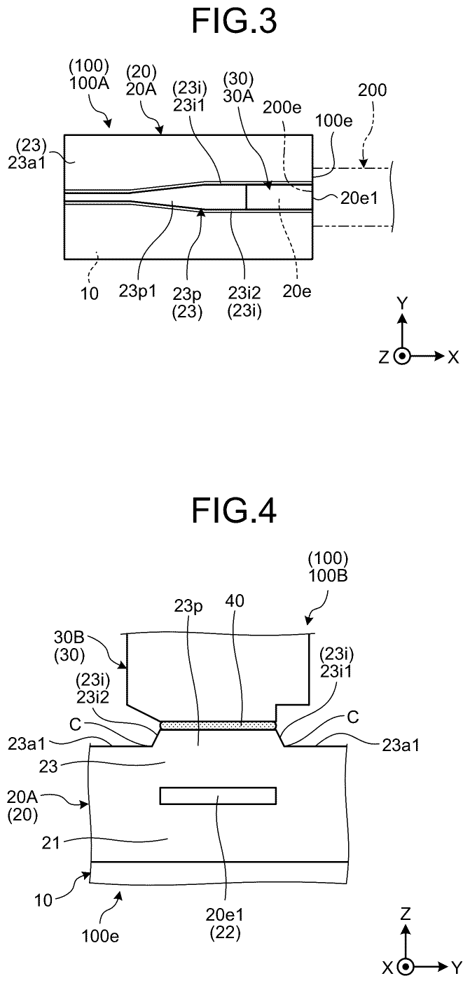

FIG. 3 is a plan view of the optical waveguide structure 100A (100) according to the first embodiment. As described above, the protruding portion 23p is formed on the opposite side to the base 10 relative to the core layer 22. Therefore, a planar shape of the protruding portion 23p as illustrated in FIG. 3 substantially represents a planar shape of the core layer 22. In the example in FIG. 3, the protruding portion 23p extends in the X direction, and the width in the Y direction of the protruding portion 23p varies. That is, the core layer 22 extends in the X direction, and the width in the Y direction of the core layer 22 varies. Moreover, the protruding portion 23p has a section in which the width in the Y direction increases as it shifts in the X direction, and the width in the Y direction at the end portion in the X direction of the protruding portion 23p is larger than the width in the Y direction at an end portion on the opposite direction to the X direction of the protruding portion 23p. That is, the core layer 22 has a section in which the width in the Y direction increases as it shifts in the X direction, and the width in the Y direction at an end portion in the X direction of the core layer 22 is larger than the width in the Y direction at an end portion on the opposite direction to the X direction of the core layer 22. The planar shape of a protruding portion 23P, that is, the planar shape of the core layer 22, is not limited to that illustrated in FIG. 3. For example, the width may be constant, or may be branched or bent.

In the configuration described above, when a relative refractive index difference between the core layer 22, and the first cladding layer 21 and the second cladding layer 23 is set to relatively high, such as 5%, because a light confinement effect in the core layer 22 is enhanced, the first cladding layer 21 and the second cladding layer 23 may be made thinner. In this case, the thicknesses t1, t3 (refer to FIG. 2) of the first cladding layer 21 and the second cladding layer 23 may be set to, for example, 10 μm, and the thickness t2 (refer to FIG. 2) of the core layer 22 may be set to, for example, 3 μm. Moreover, the width w1 (refer to FIG. 2) of the core layer 22 may be set to, for example, 1 mm or larger.

The inventers discovered, through experimental research, that when the thickness t3 of the second cladding layer 23 is thin as in the configuration described above, the slope of the inclined portion 23i relative to the surface 23al and the top surface 23p1 becomes steep compared to when it is thicker. This is presumed to be because when the thickness t3 of the second cladding layer is relatively thick at the time when laminating the second cladding layer 23 by the CVD method, an effect of reducing the steepness of the slope of the inclined portion 23i that is generated corresponding to a slope of an edge of the core layer 22 in the width direction is obtained, but when the thickness t3 is thin, the effect of reducing the steepness is less likely to be obtained, and the inclined portion 23i becomes more steep. Moreover, the inventers discovered that when the adhesive 40 having fluidity before solidification is applied on the steep inclined portion 23i as described, the adhesive 40 cannot enter a corner portion C (refer to FIG. 2) between the inclined portion 23i and the surface 23a1, to generate a gap between the corner portion C and the adhesive 40, and there is a risk that the bonding strength between the waveguide layer 20 and the member 30 by the adhesive 40 decreases, or that individual variations in bonding strength occur. When the bonding strength between the waveguide layer 20 and the member 30 decreases, the bonding strength between the optical waveguide structure 100 and the optical structure 200 also decreases, resulting in deterioration of the mechanical properties of the subassembly of the optical waveguide structure 100 and the optical structure 200.

Therefore, in the present embodiment, the adhesive 40 is not applied on the inclined portion 23i, but joins the waveguide layer 20 (the second cladding layer 23) and the member 30 at a position shifted from the inclined portion 23i, particularly, the corner portion C between the inclined portion 23i and the surface 23al, that is, a root portion of the protruding portion 23p, in other words, a position apart from the corner C.

In the example in FIG. 2, the adhesive 40 is provided on the top surface 23p1 of the protruding portion 23p, and joins the top surface 23p1 and a bottom surface 30a the member 30.

According to such a configuration, it is possible to prevent required bonding strength from not being achieved due to failure in penetration of the adhesive 40 into the corner portion C, and to prevent individual variations in bonding strength from being caused by the adhesive 40.

The configuration in which the member 30A is positioned on the protruding portion 23p as the present embodiment is more effective when the width w1 of on the core layer 22 is wide such as 1 mm or larger.

It can be identified that the second cladding layer 23 has been laminated by the CVD method, which results in the steep inclined portion 23i described above, based on inclusion of tetraethoxysilane in the second cladding layer 23.

Moreover, it was found, through research by the inventers, that the steep inclined portion 23i with the corner portion C that is difficult for the adhesive 40 to penetrate is more likely to be generated, for example, when the thickness t3 of the second cladding layer 23 is thin, such as 15 μm or smaller. That is, the configuration of the present embodiment is more effective when the thickness t3 of the second cladding layer 23 is equal to or smaller than 15 μm.

FIG. 4 is a front view of an optical waveguide structure 100B (100) according to a second embodiment. As is evident from comparison between FIG. 4 and FIG. 2, a shape of a member 30B (30) differs from that of the member 30A (30) of the first embodiment.

In the present embodiment, the width of the member 30B in the Y direction at a position apart from the joint portion with the adhesive in the Z direction is wider than the width in the Y direction of the joint portion. According to the present embodiment, it is possible to make an area of the end surface 100e that is bonded with the end surface 200e of the other optical structure 200 larger, and to thereby increase the bonding strength with the optical structure 200.

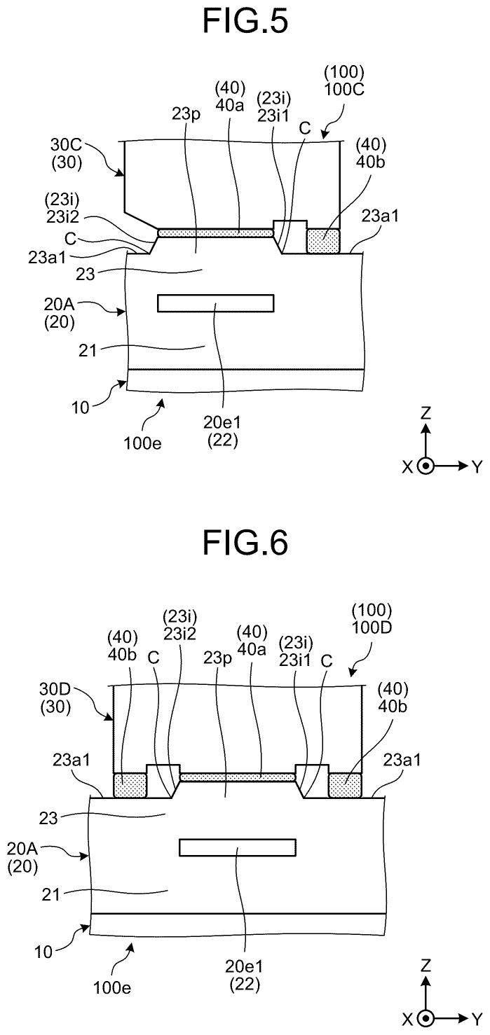

FIG. 5 is a front view of an optical waveguide structure 100C (100) according to a third embodiment. In the present embodiment, a member 30C (30) and the waveguide layer 20 are joined by the adhesive 40 provided at multiple positions (in this example, two positions). The adhesive 40 includes an adhesive 40a that joins the protruding portion 23p and the member 30C, and an adhesive 40b that joins the surface 23al and the member 30C at a position shifted from the inclined portion 23i and apart from the corner portion C. In this case, between the adhesives 40a and 40b, the inclined portion 23i is positioned. The adhesive 40a is one example of a first adhesive, and the second adhesive 40b is one example of a second adhesive.

According to the present embodiment, because the adhesive 40 is provided at two positions, the bonding strength between the component C and the waveguide layer 20 may be increased. Moreover, because the adhesive 40 is arranged at two positions apart from each other in the Y direction, the member 30C has a wider width in the Y direction, and it is thereby possible to increase an area of the end surface 100e bonded with the end surface 200e of the optical structure 200, and to thereby increase the bonding strength with the optical structure 200.

FIG. 6 is a front view of an optical waveguide structure 100D (100) according to a fourth embodiment. In the present embodiment also, a member 30D (30) and the waveguide layer 20 are joined by the adhesive 40 provided at multiple positions (in this example, three positions). The adhesive 40 includes an adhesive 40a that joins the protruding portion 23p and the member 30D, and two adhesives 40b that join the surface 23al and the member 30C at positions shifted from the inclined portion 23i and apart from the corner portion C. Moreover, in the present embodiment, between the two adhesives 40b, the two inclined portions 2311, 2312 are positioned.

According to the present embodiment, because the adhesive 40 is provided at three positions, the bonding strength between the component C and the waveguide layer 20 may be increased. Moreover, because the adhesive 40 is arranged at three positions apart from each other in the Y direction, the member 30C has a wider width in the Y direction, and it is thereby possible to increase an area of the end surface 100e bonded with the end surface 200e of the optical structure 200, and to thereby increase the bonding strength with the optical structure 200.

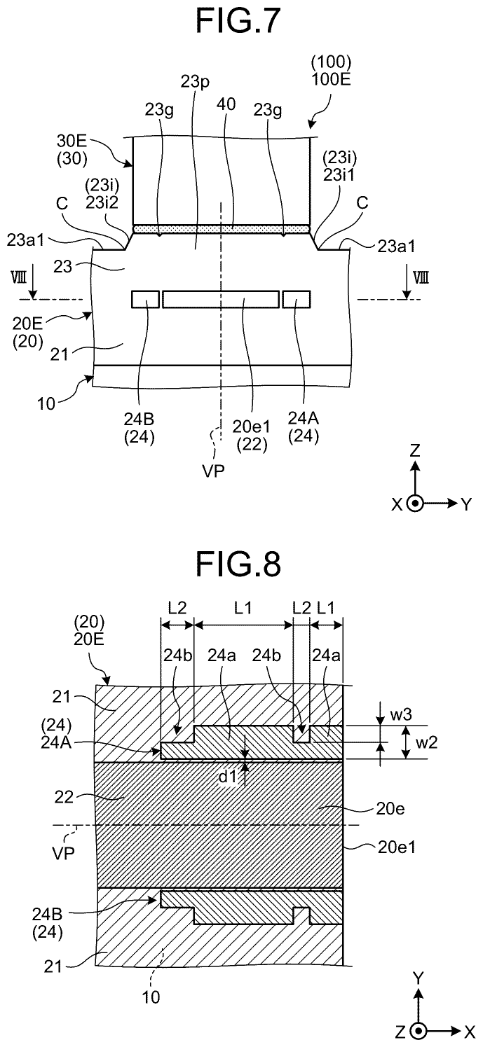

FIG. 7 is a front view of an optical waveguide structure 100E (100) according to a fifth embodiment. In a waveguide layer 20E (20) of the present embodiment, dummy layers 24A, 24B (24) aligned with the core layer 22 in the Y direction are arranged.

The dummy layer 24 is laminated in the same process as the core layer 22. The dummy layer 24 is made of the same material as the core layer 22, and has the same thickness t2 (refer to FIG. 2) as the core layer 22. Furthermore, between the dummy layer 24 and the core layer 22, the second cladding layer 23 is present. Therefore, light is less likely to leak from the core layer 22 to the dummy layer 24. The dummy layer 24A that is shifted from the core layer 22 in the Y direction is one example of a first dummy layer, and the second dummy layer 24B that is shifted from the core layer 22 in the opposite direction of the Y direction is one example of a second dummy layer.

As is evident from FIG. 7, in this case, the protruding portion 23p is formed to cover the core layer 22 and the two dummy layers 24. That is, the protruding portion 23p includes a portion positioned on the opposite side to the base 10 relative to the dummy layer 24.

With such a configuration, the width of the protruding portion 23p in the Y direction may be made wide. In this case, the width of the adhesive 40 in the Y direction may be widened, and the bonding strength between the protruding portion 23p and a member 30E may be thereby increased. Moreover, as the widths of the protruding portion 23p and the adhesive 40 increase, the member 30E has a wider width in the Y direction and, therefore, an area of the end surface 100e bonded with the end surface 200e of the optical structure 200 may be increased, and the bonding strength with the optical structure 200 may be thereby enhanced.

On the top surface 23p1, a groove 23g is formed at the position aligned in the Z direction between the core layer 22 and the dummy layer 24. A depth of the groove 23g is set to be shallower than the height of the protruding portion 23p, that is, the thickness t2 of the core layer 22, allowing the adhesive 40 to penetrate. Therefore, it is possible to avoid a situation that the adhesive 40 does not penetrate into the groove 23g, to form a gap between the adhesive 40 and the protruding portion 23p, and that the bonding strength between the waveguide layer 20 and the member 30E by the adhesive 40 decreases.

FIG. 8 is a cross-section taken along a line VIII-VIII in FIG. 7. As illustrated in FIG. 8 viewing the cross-section in an opposite direction to the Z direction, in the dummy layer 24, a concave shape 24b and a convex shape 24a are arranged at an edge on the opposite side to the core layer 22. The concave shape 24b and the convex shape 24a are formed by alternately arranging an edge that extends in the X direction and an edge that extends in the Y direction, in the plan view of FIG. 8. If light leaks from the core layer 22 to the dummy layer 24, it is not preferable that the leaked light be transmitted in the X direction toward the optical structure 200. Therefore, in the present embodiment, to change the effective refractive index discontinuously along the X direction at the position of the dummy layer 24 in the waveguide layer 20, the concave shape 24b and the convex shape 24a are arranged. With such a configuration, light transmitted to the dummy layer 24 leaks to the outside of the dummy layer 24 from the concave shape 24b and the convex shape 24a. As one example, a width w2 in of the convex shape 24a in the Y direction is 500 μm, and a width w3 of the concave shape 24b in the Y direction is 250 μm. A length L1 of the convex shape 24a in the X direction is equal to or larger than 300 μm and equal to or smaller than 2000 μm, and a length L2 of the concave shape 24b in the X direction is equal to or larger than 200 μm and equal to or smaller than 1000 μm. Moreover, a distance d1 between the core layer 22 and the dummy layer 24 is 10 μm. However, values of these width w2, width w3, length L1, length L2, and distance d1 are only examples, and are not limited to the above values. The concave shape 24b and the convex shape 24a are one example of a leakage portion.

An optical waveguide structure 10E of the present embodiment has a structure symmetrical with respect to a virtual plane VP. The virtual plane VP extends along the X direction and the Z direction, and is perpendicular to the Y direction. Therefore, the dummy layer 24B also has a structure symmetrical with respect to the dummy layer 24A. Accordingly, with the dummy layer 24B also, an effect similar to that of the dummy layer 24A may be obtained.

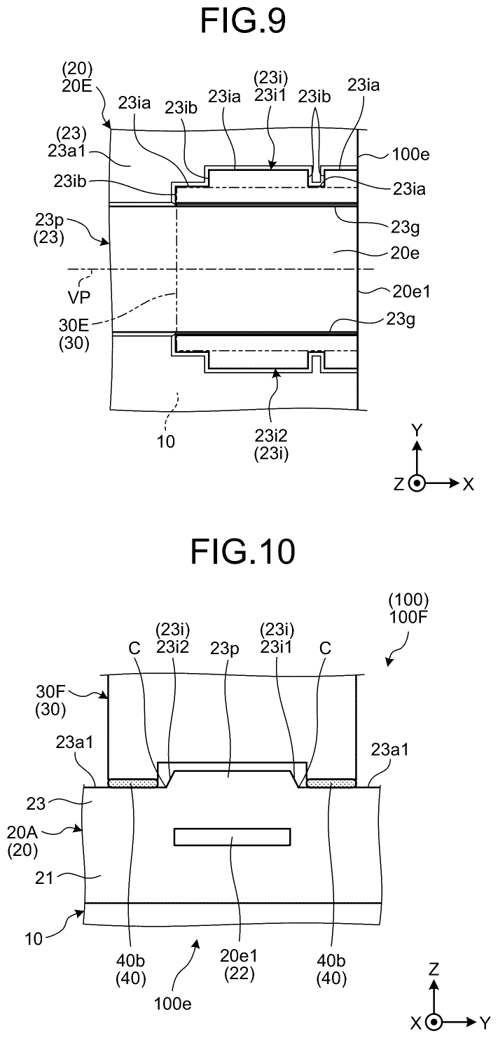

FIG. 9 is a plan view of the waveguide layer 20E of the optical waveguide structure 100E, in other words, a plan view illustrating a state before the member 30E is mounted on the waveguide layer 20E in a manufacturing process of the optical waveguide structure 100E. In the present embodiment, at an end portion of the waveguide layer 20 in the Z direction, the protruding portion 23p corresponding to the core layer 22 and the dummy layer 24 is formed. That is, the protruding portion 23p has a shape corresponding to the concave shape 24b and the convex shape 24a in the plan view in the opposite direction to the Z direction. That is, the inclined portion 23i1 positioned at the end portion of the protruding portion 23p in the Y direction and the inclined portion 2312 positioned at the end portion in the opposite direction of the Y direction have a section 23ia extending in the X direction and a section 23ib extending in the Y direction, respectively. In this case, as illustrated in FIG. 9, these sections 23ia, 23ib may be used for positioning of the member 30E when the member 30E is mounted on the waveguide layer 20. That is, the sections 23ia, 23ib of the inclined portion 23i are one example of alignment marker.

FIG. 10 is a front view of an optical waveguide structure 100F (100) according to a sixth embodiment. In the present embodiment also, a member 30F (30) and the waveguide layer 20 are joined by the adhesive 40 that is provided at multiple positions (in this example, two positions). The adhesive 40 includes two adhesives 40b that join the surface 23al and the member 30F at positions shifted from the inclined portion 23i and apart from the corner portion C. Moreover, in the present embodiment, between the two adhesives 40b, the two inclined portions 2311, 2312 are positioned.

According to the present embodiment, because the adhesive 40 is provided at two positions, the bonding strength between the member 30F and the waveguide layer 20 may be increased. Moreover, because the adhesive 40 is arranged at two positions apart from each other in the Y direction, the member 30F has a wider width in the Y direction, and it is thereby possible to increase an area of the end surface 100e bonded with the end surface 200e of the optical structure 200, and to thereby increase the bonding strength with the optical structure 200. As is evident from the example in FIG. 10, it is not essential for the member 30F (30) and the protruding portion 23p to be bonded with the adhesive 40.

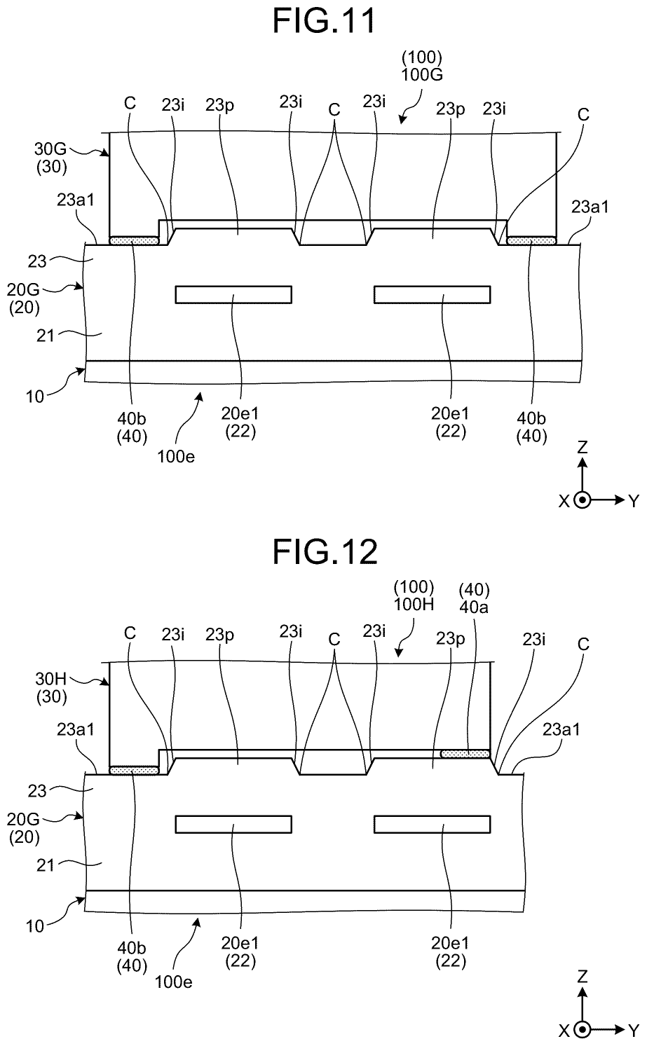

FIG. 11 is a front view of an optical waveguide structure 100G (100) according to a seventh embodiment. In the present embodiment also, a member 30G (30) and a waveguide layer 20G (20) are joined by the adhesive 40 that is provided at multiple positions (in this example, two positions). The adhesive 40 includes two adhesives 40b that join the surface 23al and the member 30G at positions shifted from the inclined portion 23i and apart from the corner portion C. Moreover, in the present embodiment, between the two adhesives 40b, the two protruding portions 23p, that is, the four inclined portions 23i are positioned.

According to the present embodiment, because the adhesive 40 is provided at two positions, the bonding strength between the member 30G and the waveguide layer 20 may be increased. Moreover, because the adhesive 40 is arranged at two positions apart from each other in the Y direction, the member 30G has a wider width in the Y direction, and it is thereby possible to increase an area of the end surface 100e bonded with the end surface 200e of the optical structure 200, and to thereby increase the bonding strength with the optical structure 200. Furthermore, in the present embodiment, the single member 30G functions as a reinforcing member corresponding to the multiple protruding portions 23p (the core layer 22). In this case, compared to a configuration in which the member 30 is provided individually for each of the multiple protruding portions 23p (the core layer 22), the number of parts may be reduced, resulting in an advantage of reducing manufacturing effort and costs also.

FIG. 12 is a front view of an optical waveguide structure 100H (100) according to an eight embodiment. In the present embodiment also, a member 30H (30) and the waveguide layer 20 are joined by the adhesive 40 that is provided at multiple positions (in this example, two positions). The adhesive 40 includes the adhesive 40a that joins the protruding portion 23p and the member 30H, and the two adhesives 40b that join the surface 23al and the member 30H at positions shifted from the inclined portion 23i and apart from the corner portion C. Moreover, in the present embodiment, between the two adhesives 40a and 40b, the three inclined portions 23i are positioned.

According to the present embodiment, because the adhesive 40 is provided at two positions, the bonding strength between the member 30H and the waveguide layer 20 may be increased. Moreover, because the adhesive 40 is arranged at two positions apart from each other in the Y direction, the member 30H has a wider width in the Y direction, and it is thereby possible to increase an area of the end surface 100e bonded with the end surface 200e of the optical structure 200, and to thereby increase the bonding strength with the optical structure 200. Furthermore, in the present embodiment also, because the single member 30H is shared by the multiple protruding portions 23p (the core layer 22), the number of parts may be reduced, resulting in an advantage of reducing manufacturing effort and costs also.

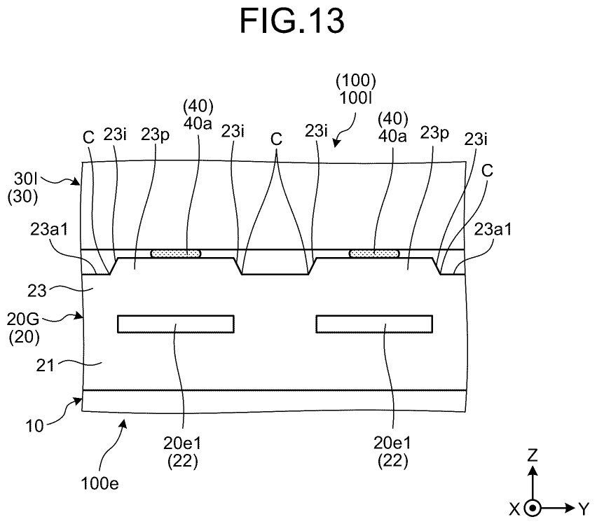

FIG. 13 is a front view of an optical waveguide structure 100I (100) according to a ninth embodiment. In the present embodiment also, a member 30I (30) and the waveguide layer 20 are joined by the adhesive 40 that is provided at multiple positions (in this example, two positions). The adhesive 40 includes the multiple adhesives 40a that joins the protruding portion 23p and the member 30I. Moreover, in the present embodiment, between the two adhesives 40a adjacent to each other in the Y direction, the two inclined portions 23i are positioned. The member 30I is arranged to cover the two or more protruding portions 23p.

According to the present embodiment, because the adhesive 40 is provided at two positions, the bonding strength between the member 30I and the waveguide layer 20 may be increased. Moreover, because the adhesive 40 is arranged at two positions apart from each other in the Y direction, the member 30I has a wider width in the Y direction, and it is thereby possible to increase an area of the end surface 100e bonded with the end surface 200e of the optical structure 200, and to thereby increase the bonding strength with the optical structure 200. Furthermore, in the present embodiment also, because the single member 30I is shared by the multiple protruding portions 23p (the core layer 22), the number of parts may be reduced, resulting in an advantage of reducing manufacturing effort and costs also.

As the embodiments described above, various combinations may be applied to the positions of the multiple adhesives 40.

For example, in the embodiment described above, the optical waveguide structure is PLC, but it is not limited thereto, and the optical waveguide structure may be, for example, an SiPh waveguide, an InP waveguide, or an SiN waveguide.

According to the present disclosure, it is possible to obtain an optical waveguide structure with an improved and novel structure enabling to improve mechanical properties of, for example, a subassembly that integrates the optical waveguide structure and other components.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical waveguide structure comprising:
a first member having a first surface facing a first direction;
a waveguide layer including
a core layer extending in a second direction that intersects the first direction at a position apart from the first surface, and
a cladding layer surrounding the core layer on the first surface, the cladding layer including
a protruding portion protruding in the first direction to a peripheral portion at a position on an opposite side to the first member at least with respect to the core layer, and
an inclined portion arranged at a boundary between the protruding portion and the peripheral portion;
a second member arranged on an opposite side to the first member with respect to an end portion in a longitudinal direction of the waveguide layer; and
an adhesive configured to join the cladding layer and the second member at a position shifted from the inclined portion.

2. The optical waveguide structure according to claim 1, wherein the adhesive includes a first adhesive joining the protruding portion and the second member.

3. The optical waveguide structure according to claim 1, wherein the adhesive includes a second adhesive joining the peripheral portion and the second member.

4. The optical waveguide structure according to claim 1, wherein the adhesive includes: a first adhesive joining the protruding portion and the second member; and a second adhesive joining the peripheral portion and the second member.

5. The optical waveguide structure according to claim 1, wherein the adhesive includes a plurality of adhesives joining the cladding layer and the second member.

6. The optical waveguide structure according to claim 5, wherein the inclined portion is positioned between the plurality of adhesives.

7. The optical waveguide structure according to claim 5, wherein, as the inclined portion, a plurality of inclined portions are positioned between the adhesives.

8. The optical waveguide structure according to claim 7, wherein
the inclined portion includes:
a first inclined portion positioned at an end portion in a third direction intersecting the first direction and the second direction in the protruding portion; and
a second inclined portion positioned at an end portion in an opposite direction of the third direction in the protruding portion, and
the first inclined portion and the second inclined portion are positioned between the adhesives.

9. The optical waveguide structure according to claim 2, wherein
the waveguide layer includes a dummy layer aligned with the core layer maintaining a gap in a direction intersecting with the first direction and the second direction, and
the protruding portion includes a portion positioned on an opposite side to the first member with respect to the dummy layer.

10. The optical waveguide structure according to claim 9, wherein the dummy layer includes:
a first dummy layer shifted in a third direction that intersects with the first direction and the second direction with respect to the core layer; and
a second dummy layer shifted in an opposite direction in the third direction with respect to the core layer.

11. The optical waveguide structure according to claim 10, wherein the dummy layer includes a leakage portion from which light leaks.

12. The optical waveguide structure according to claim 11, wherein the leakage portion has a concave shape or a convex shape when viewed in an opposite direction to the first direction, at an edge on an opposite side to the core layer of the dummy layer.

13. The optical waveguide structure according to claim 1, wherein a thickness in the first direction of the cladding layer laminated on the core layer is equal to or smaller than 15 μm.

14. The optical waveguide structure according to claim 1, wherein the cladding layer includes tetraethoxysilane.

15. The optical waveguide structure according to claim 1, wherein a width of the core layer in a third direction intersecting with the first direction and the second direction is equal to or larger than 1 mm.
